(19) United States
(12) Patent Application Publication
(10) Pub. No.: US 2007/0091481 A1
(43) Pub. Date: Apr. 26, 2007

(54) Variable-shape mirror and optical pickup apparatus therewith

(75) Inventors: Hideki Chouji, Osaka (JP); Shigeo Maeda, Osaka (JP); Hideroshi Kotera, Kyoto (JP); Isaku Kanno, Kyoto (JP)

Correspondence Address: MORGAN LEWIS & BOCKIUS LLP, 1111 PENNSYLVANIA AVENUE NW, WASHINGTON, DC, 20004, US

(73) Assignee: Funai Electric Co., Ltd.

(21) Appl. No.: 11/585,858

(22) Filed: Oct. 25, 2006

(30) Foreign Application Priority Data
Oct. 26, 2005 (JP) 2005-310827
Oct. 10, 2006 (JP) 2006-276284

(51) Int. Cl. G02B 5/08

(52) U.S. Cl. 359/846

(57) ABSTRACT

A variable-shape mirror has a driver portion, which includes a piezoelectric film and first and second electrode films that sandwich it therebetween, and a substrate arranged on the first electrode film to support the driver portion. As the driver portion is driven, the shape of a mirror film is varied. The substrate is formed of at least one material selected from the group of Si, SiO₂, and MgO. The piezoelectric film is formed of PZT or of a perovskite oxide that contains Nb and that is the same kind as PZT. The first electrode film is formed of a plurality of layers of different compositions, and, of those layers, the one formed on the substrate is a metal layer of a composition containing at least one element selected from the group of Ti, Cr, and W and the one formed on the piezoelectric film is a metal layer of a composition containing at least one element selected from the group of Pt, Ir, and Ru.

This application is based on Japanese Patent Application No. 2005-310827 filed on Oct. 26, 2005 and Japanese Patent Application No. 2006-276284 filed on Oct. 10, 2006, the contents of which are hereby incorporated by reference.

### BACKGROUND OF THE INVENTION

1. Field of the Invention

The present invention relates to a variable-shape mirror, i.e. a mirror that can vary the mirror surface shape thereof, for use in an optical pickup device or the like, and more particularly to a variable-shape mirror that is so structured as to have a plurality of thin films formed on one another. The present invention also relates to an optical pickup apparatus incorporating such a variable-shape mirror.

2. Description of Related Art

When information is read from or written to an optical disc such as a CD (compact disc) or DVD (digital versatile disc) by use of an optical pickup device, the relationship between the optical axis of the optical pickup device and the disc surface should ideally be perpendicular. In reality, however, while the disc is rotating, the relationship does not remain perpendicular all the time. Thus, with an optical disc such as a CD or DVD, when the disc surface slants relative to the optical axis, the optical path of the laser light bends, producing wavefront aberrations (mainly coma aberration). Also when optical discs to which to record information or from which to retrieve information by use of an optical pickup apparatus are exchanged, differences in the thickness of the disc substrate from one optical disc to another produce wavefront aberrations (mainly spherical aberration).

When such wavefront aberrations occur, the position of the spot of the laser light shone on the optical disc deviates from the right position. When the wavefront aberrations are larger than are tolerated, inconveniently, it is no longer possible to read or write information correctly. For this reason, conventionally, variable-shape mirrors have been used to correct for wavefront aberrations, and various variable-shape mirrors have been proposed.

For example, JP-A-2004-347753 proposes a variable-shape mirror as shown in FIG. 7 which is so structured as to have the following films formed on one another in the order named on a silicon substrate 101: a second electrode film 102, a piezoelectric film 103, a first electrode film 104, an elastic plate film 105, and a reflective mirror film 106. For another example, JP-A-2005-032286 proposes a variable-shape mirror as shown in FIG. 8 which has, formed on a substrate 201, a lower electrode 202, a piezoelectric member 203, and upper electrodes 204 and 205 and which has a reflective film 207 formed in a cavity portion 206 provided on the bottom side of the substrate 201.

Disadvantageously, however, the variable-shape mirrors structured as proposed in JP-A-2004-347753 and JP-A-2005-032286 mentioned above tend to suffer film exfoliation between the substrate (e.g., Si) and the electrode film (e.g., Pt or Ir) and/or between the piezoelectric film (e.g., PZT) and the electrode film (e.g., Au), resulting in breakage of the variable-shape mirrors. This tendency is especially remarkable between the substrate and the electrode film formed thereon. If a variable-shape mirror breaks after the assembly of the optical pickup apparatus incorporating it, inconveniently, not simply is it impossible to correct for aberrations, but the optical pickup apparatus cannot even function as such.

### SUMMARY OF THE INVENTION

In view of the conventionally experienced inconveniences mentioned above, it is an object of the present invention to provide a variable-shape mirror that prevents film exfoliation between a substrate and an electrode film formed thereon and between a piezoelectric film and an electrode film formed thereon. It is another object of the present invention to provide an optical pickup apparatus that can correct for aberrations accurately and that offers high durability as a result of the optical pickup apparatus incorporating a variable-shape mirror that prevents film exfoliation between a substrate and an electrode film formed thereon and between a piezoelectric film and an electrode film formed thereon.

To achieve the above objects, according to the present invention, a variable-shape mirror is provided with: a driver portion including a piezoelectric film and first and second electrode films that sandwich the piezoelectric film therebetween; a substrate formed on the first electrode film to support the driver portion; and a mirror film whose shape is varied as the driver portion is driven. Here, the first electrode film is composed of a plurality of layers of different compositions, and, of those layers, the one formed on the substrate is of such a composition as to exhibit enhanced adhesion to the substrate and the one formed on the piezoelectric film is of such a composition as to exhibit enhanced adhesion to the piezoelectric film.

With this structure, in a variable-shape mirror that is so structured as to have a plurality of thin films formed on one another, the electrode film (the first electrode film) sandwiched between the substrate and the piezoelectric film is formed in two or more layers so as to have different compositions in the part thereof kept in contact with the substrate and in the part thereof kept in contact with the piezoelectric film. The substrate and the part of the first electrode film kept in contact therewith are of such compositions as to exhibit enhanced adhesion therebetween, and so are the piezoelectric film and the part of the first electrode film kept in contact therewith. This helps prevent film exfoliation as has conventionally been experienced frequently in the electrode film sandwiched between the substrate and the piezoelectric film.

Moreover, according to the present invention, in the variable-shape mirror structured as described above, the substrate may be formed of at least one substance selected from the group of Si, SiO₂, and MgO; the piezoelectric film may be formed of lead zirconate titanate (PZT) or of a perovskite oxide that contains Nb and that is the same kind as lead zirconate titanate (PZT); of the plurality of layers mentioned above, the one formed on the substrate may be a metal layer of a composition containing at least one element selected from the group of Ti, Cr, and W; and, of the plurality of layers mentioned above, the one formed on the piezoelectric film may be a metal layer of a composition containing at least one element selected from the group of Pt, Ir, and Ru.

With this structure, it is possible, by use of substances that are easily available and from which the desired properties can be easily obtained, to realize a variable-shape mirror that prevents film exfoliation as has conventionally been experienced frequently in the electrode film sandwiched between the substrate and the piezoelectric film.

Moreover, according to the present invention, in the variable-shape mirror structured as described above, the second electrode film may be a metal layer of a composition containing at least one element selected from the group of Pt, Ir, Ru, Al, and Ti.

With this structure, of the two electrode films that sandwich the piezoelectric film, the other (the second electrode film) has a particular composition. Here, by selecting a composition that enhances the adhesion between the piezoelectric film and the second electrode film, it is possible to more securely prevent film exfoliation among the thin films provided in the variable-shape mirror; or, given the low incidence of film exfoliation around the second electrode film, by selecting a composition that is inexpensively available, it is possible to minimize the cost of the variable-shape mirror.

Moreover, according to the present invention, in the variable-shape mirror structured as described above, an insulating layer may be formed on the surface of the second electrode film opposite from the surface thereof kept in contact with the piezoelectric film, and the mirror film may be formed on the surface of the insulating layer opposite from the surface thereof kept in contact with the second electrode film.

With this structure, the mirror film is formed across the insulating layer from the electrode. This makes it easy to form the mirror film flat and smooth, and in addition makes it possible to form the mirror film without being influenced by the structure of the electrode film (as where the electrode film consists of discrete segments and has surface irregularities). This makes it easy to fabricate a variable-shape mirror that is less prone to breakage and from which the desired mirror shape can be easily obtained.

Moreover, according to the present invention, in the variable-shape mirror structured as described above, the part of the substrate where the driver portion is formed may be wholly or partly given a thickness of 20 μm or more but 100 μm or less.

With this structure, the substrate has adequate rigidity. Moreover, even where the driver portion is driven with a low voltage so that the variable-shape mirror is driven with less burden, since the substrate is not excessively thick, the desired mirror shape can be obtained.

Moreover, according to the present invention, in the variable-shape mirror structured as described above, the piezoelectric film may be given a thickness of 0.5 μm or more but 5 μm or less, and the second electrode film may be given a thickness of 0.5 μm or less.

With this structure, the piezoelectric film can exert a sufficient force to produce the desired mirror shape, and it simultaneously has an adequate thickness to make film exfoliation less likely to result from the stress within the film. Moreover, forming the second electrode film thin helps reduce the influence of its action of suppressing the lateral expansion-contraction (in the direction parallel to the films formed on one another) of the piezoelectric film, and thus makes it possible to drive the variable-shape mirror with a low drive voltage.

Moreover, according to the present invention, an optical pickup apparatus is provided with the variable-shape mirror structured as described above.

With this structure, thanks to the enhanced adhesion between the substrate of the variable-shape mirror and the electrode film and between the electrode film and the piezoelectric film, it is possible to realize an optical pickup apparatus that is less prone to breakage resulting from film exfoliation among the thin films provided in the variable-shape mirror and that thus offers high durability. Moreover, it is possible to realize an optical pickup apparatus in which the mirror shape of the variable-shape mirror can be easily varied into the desired shape and that thus permits proper correction for aberrations with ease.

### BRIEF DESCRIPTION OF THE DRAWINGS

FIG. 1 is a schematic diagram showing the construction of the optical system of an optical pickup apparatus embodying the present invention;

FIG. 2A is a diagram showing the structure of the variable-shape mirror incorporated in the optical pickup apparatus embodying the present invention, the diagram being a schematic front view of the variable-shape mirror as seen from the mirror surface side thereof;

FIG. 2B is a schematic cross-sectional view along line A-A shown in FIG. 2A;

FIG. 2C is a diagram showing the variable-shape mirror shown in FIG. 2A as seen from the bottom side thereof;

FIG. 3 is a schematic plan view showing the structure of the lower electrode of the variable-shape mirror of the embodiment;

FIG. 4 is a schematic plan view showing the structure of the upper electrodes of the variable-shape mirror of the embodiment;

FIG. 5 is a table showing how the adhesion between the silicon substrate and the lower electrode film (first layer) formed thereon is improved in the variable-shape mirror of the embodiment;

FIG. 6 is a table showing how the adhesion between the piezoelectric film and the lower electrode film (second layer) formed thereon is improved in the variable-shape mirror of the embodiment;

FIG. 7 is a diagram showing the structure of a conventional variable-shape mirror;

FIG. 8 is a diagram showing the structure of a conventional variable-shape mirror; and

FIG. 9 is a plot showing the relationship between the thickness of the substrate provided in the variable-shape mirror and the displacement of the mirror center.

### DETAILED DESCRIPTION OF PREFERRED EMBODIMENTS

Hereinafter, an embodiment of the present invention will be described with reference to the drawings. It should however be understood that the embodiment presented below is merely an example and is not meant to limit the present invention in any way.

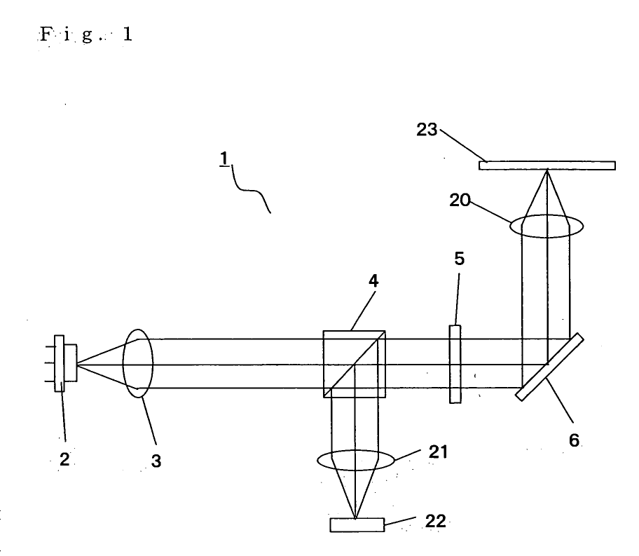

FIG. 1 is a schematic diagram showing the optical system of an optical pickup apparatus incorporating a variable-shape mirror embodying the present invention. In FIG. 1, the optical pickup apparatus 1 is capable of, on one hand, irradiating an optical recording medium 23, such as a CD, DVD, or blue-laser DVD (a high-capacity, high-definition DVD), with a laser beam and receiving the light reflected therefrom in order to read the information recorded on a recording surface of the recording medium 23 and, on the other hand, irradiating the recording medium 23 with a laser beam in order to write information to a recording surface thereof. The optical pickup apparatus 1 includes, for example, a laser light source 2, a collimator lens 3, a beam splitter 4, a quarter-wave plate 5, a variable-shape mirror 6, an objective lens 20, a condenser lens 21, and a photodetector 22.

The laser light source 2 is a semiconductor laser diode that emits a laser beam of a predetermined wavelength. Used here is, for example a semiconductor laser diode that can emit a laser beam of a wavelength of 785 nm for CDs, 650 nm for DVDs, or 405 nm for blue-laser DVDs. In the embodiment, it is assumed that a single laser light source 2 emits a laser beam of a single wavelength; it is however also possible to use instead a laser light source that can emit laser beams of a plurality of wavelengths. The laser beam emitted from the laser light source 2 is directed to the collimator lens 3.

The collimator lens 3 converts the laser beam emitted from the laser light source 2 into a parallel light beam. The parallel light beam here is so called because all the rays constituting the beam, which originates from the laser light source 2, are approximately parallel to the optical axis. The parallel light beam transmitted through the collimator lens 3 is then directed to the beam splitter 4.

The beam splitter 4, on one hand, transmits the laser beam transmitted through the collimator lens 3 and, on the other hand, reflects the laser beam reflected back from the recording medium 23 to direct it to the photodetector 22. The laser beam transmitted through the beam splitter 4 is directed to the quarter-wave plate 5.

The quarter-wave plate 5 cooperates with the beam splitter 4 to function as a light isolator. The laser beam transmitted through the quarter-wave plate 5 is directed to the variable-shape mirror 6.

The variable-shape mirror 6 is inclined, for example, at 45 degrees relative to the optical axis of the laser beam emitted from the laser light source 2. The variable-shape mirror 6 reflects the laser beam transmitted through the beam splitter 4 to direct it to the objective lens 20. The variable-shape mirror 6 also corrects for wavefront aberrations in the laser beam by varying the shape of the mirror surface provided therein. The structure of the variable-shape mirror 6 will be described in detail later.

The objective lens 20 focuses the laser beam reflected from the variable-shape mirror 6 on an information recording surface formed inside the recording medium 23.

The laser beam reflected from the recording medium 23 is transmitted through the objective lens 20, and is then reflected on the variable-shape mirror 6. The laser beam reflected from the variable-shape mirror 6 is then transmitted through the quarter-wave plate 5, is then reflected on the beam splitter 4, and is then directed to the condenser lens 21. The condenser lens 21 focuses the laser beam reflected from the recording medium 23 on the photodetector 22.

On receiving the laser beam, the photodetector 22 converts optical information into an electrical signal, which it then feeds to an RF amplifier or the like provided in an unillustrated optical disc apparatus or the like. This electrical signal contains information retrieved from the data recorded on the recording surface and information (servo information) needed to control the position of the optical pickup apparatus 1 as a whole and of the position of the objective lens 20.

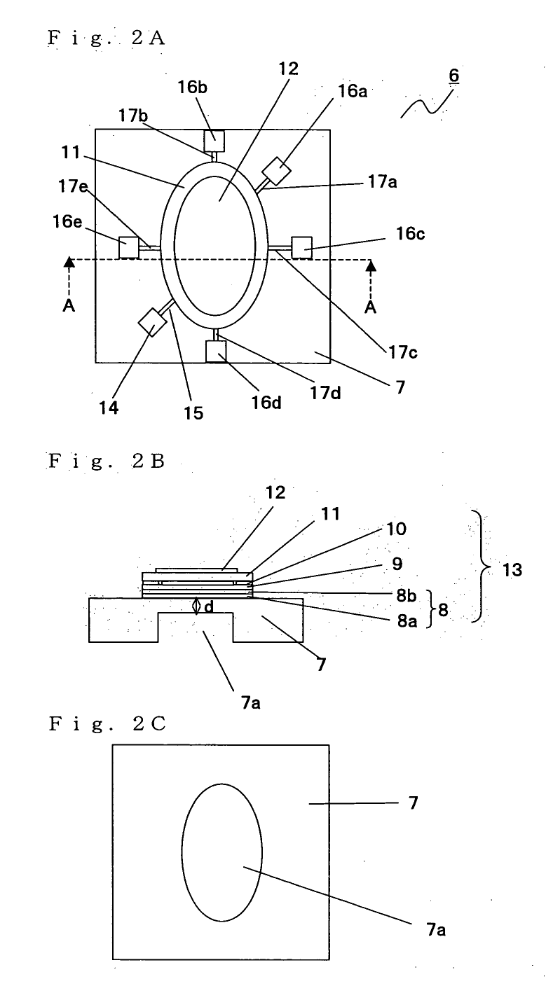

Next, the structure of the variable-shape mirror 6 used in the embodiment will be described in detail. FIG. 2A is a diagram showing the structure of the variable-shape mirror 6 used in the optical pickup apparatus 1 of the embodiment, the diagram being a schematic front view of the variable-shape mirror 6 as seen from the mirror surface side thereof. FIG. 2B is a schematic cross-sectional view along line A-A shown in FIG. 2A. FIG. 2C is a diagram showing the variable-shape mirror 6 shown in FIG. 2A as seen from the bottom side thereof.

As shown in FIGS. 2A to 2C, in the embodiment, the variable-shape mirror 6 includes a substrate 7, a lower electrode film 8 (first electrode film) formed on the substrate 7, a piezoelectric film 9 formed on the lower electrode film 8, an upper electrode film 10 (second electrode film) formed on the piezoelectric film 9, an insulating film 11 formed on the upper electrode film 10, and a mirror film 12 formed on the insulating film 11. The lower electrode film 8, the piezoelectric film 9, and the upper electrode film 10 together constitute a driver portion 13.

The substrate 7 serves to support the driver portion 13, the insulating film 11, and the mirror film 12. In the embodiment, the substrate 7 is formed of silicon (Si), with consideration given to the later-described relationship with the material of the lower electrode film 8. This however is not meant to limit the material of the substrate 7 to silicon; just for reasons similar to those for which silicon is selected as the material of the substrate 7, it is also possible to select instead silicon oxide (SiO₂), magnesium oxide (MgO), a mixture of two or more substances selected from Si, SiO₂, and MgO, or the like.

The substrate 7 has a cavity 7a formed therein. With this cavity 7a, part of the substrate 7 has a thickness d (see FIG. 2B) smaller than the other part thereof. This permits the mirror film 12 to vary its shape easily as the driver portion 13 is driven. The cavity 7a is formed, for example, by etching away or otherwise removing part of the substrate 7, which is originally formed as a thick plate.

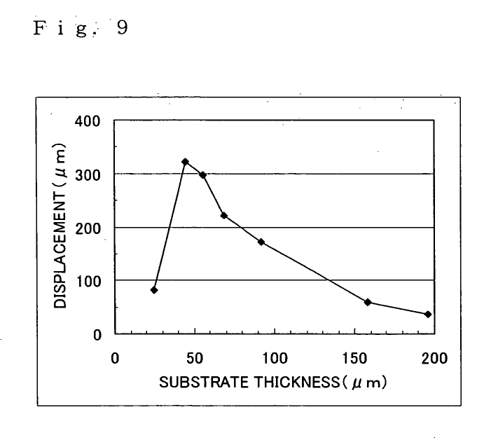

FIG. 9 is a plot of the results of an experiment conducted with a variable-shape mirror structured similarly to that of the embodiment except for the substrate: while the thickness of the substrate (for FIG. 9, a silicon substrate was used) was varied, at each of different substrate thicknesses, the displacement (μm) of the central part of the mirror was measured with a fixed voltage applied to the piezoelectric film. FIG. 9 demonstrates that forming the substrate 7 too thin or too thick leads to the variable-shape mirror offering too small a mirror displacement.

For this reason, in the substrate 7 of this embedment, it is preferable that the thickness d of the part of the substrate 7 where it is made thinner with the cavity 7a formed therein be 20 μm or more but 100 μm or less. In the embodiment, for better handling of the variable-shape mirror 6 during its fabrication, for easy varying of the shape of the substrate 7, and out of other considerations, part of the substrate 7 is made thinner than the other part thereof. This however is not meant to be any limitation; the substrate 7 may instead be formed uniformly thin (20 μm to 100 μm) overall.

In the embodiment, the cavity 7a is oval. This however is not meant to be any limitation; its shape may be modified within the objects of the present invention. For example, the cavity 7a may be rectangular or of any other shape. Likewise, although the substrate 7 is rectangular in the embodiment, this is not meant to be any limitation; it may be circular, polygonal, or of any other shape.

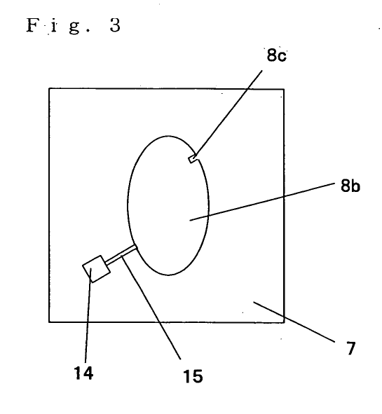

The lower electrode film 8 is formed in two layers, namely a first layer 8a and a second layer 8b, and these two layers 8a and 8b are of different compositions. This will be discussed in more detail later. FIG. 3 is a schematic plan view showing the structure of the lower electrode 8 of the variable-shape mirror 6 of the embodiment. The lower electrode film 8 is formed in an oval shape, as a single, continuous segment. The lower electrode film 8 is connected, by a lead conductor 15, to a first electrode terminal 14, that is connected further to a drive circuit (unillustrated).

The lower electrode film 8 is formed so as to avoid the area indicated by 8c in FIG. 3. This is to permit a lead conductor 17a for the upper electrode film 10 to be formed there. The shape of the lower electrode film 8 is not limited to the one it specifically has in the embodiment, but may be modified within the objects of the present invention; for example, the lower electrode film 8 may be rectangular or of any other shape. The lower electrode film 8 may even be divided into two or more discrete segments.

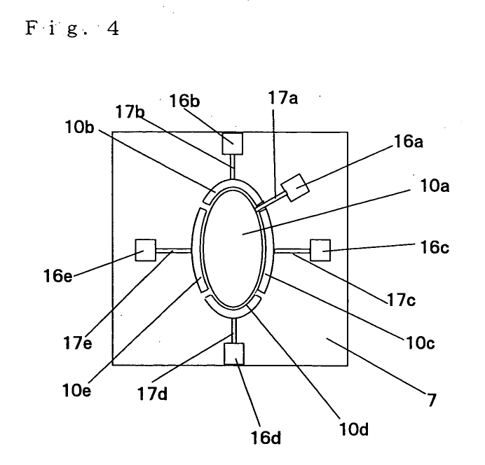

The upper electrode film 10 forms a pair with the lower electrode film 8 to serve to apply a voltage across the piezoelectric film 9, which is sandwiched between the lower electrode film 8 and the upper electrode film 10. As shown in FIG. 4, the upper electrode film 10 is divided into five discrete electrode film segments 10a to 10e, consisting of a first, oval, electrode segment 10a surrounded by four second electrode segments 10b to 10e.

For efficient exploitation of the later-described lateral expansion-contraction (in the direction parallel to the individual films shown in FIG. 2B) of the piezoelectric film 9 for the varying of the shape of the mirror film 12, it is preferable that the electrode films that sandwich the piezoelectric film 9 be as thin as possible. Specifically, it is preferable that the upper electrode film 10 be 0.5 μm or less thick, and accordingly, in the embodiment, the electrode segments 10a to 10e are given a thickness of 0.5 μm or less.

The first electrode segment 10a is so located that the center of its oval shape coincides with the center of the mirror film 12, and is so sized as to be smaller than the mirror film 12. Among the second electrode segments 10b to 10e, each pair of oppositely located electrode segments (i.e. 10b and 10d on one hand, and 10c and 10e on the other hand) is arranged symmetrically. The first electrode segment 10a and the second electrode segments 10b to 10e are respectively connected, by lead conductors 17a to 17e, to second electrode terminals 16a to 16e, which are connected further to the driver circuit (unillustrated).

In the embodiment, since the upper electrode film 10 is divided into discrete segments, different voltages can be applied across different parts of the piezoelectric film 9 sandwiched between the electrode segments 10a to 10e and the lower electrode film 8. This makes it possible to adjust the degree and direction in which to vary the shape of the piezoelectric film 9 sandwiched between the electrode segments 10a to 10e and the lower electrode film 8, and thus to vary the shape of the mirror film 12 into the desired shape. The electrode arrangement just described is particularly advantageous where the properties of the piezoelectric film 9 are not uniform overall, because it permits fine adjustment of the voltages applied across the piezoelectric film 9 by electrode segment (10a to 10e) so that the desired shape is obtained.

The shape of the upper electrode film 10 is not limited to the one it specifically has in the embodiment, but may be modified; for example, the upper electrode film 10 may be formed as a single, continuous segment, or may be divided into any other pattern.

The piezoelectric film 9 is formed on the lower electrode film 8, and is shaped identically with the lower electrode film 8. When a voltage is applied between the lower electrode film 8 and the upper electrode film 10, the piezoelectric film 9 expands or contracts according to the polarity of the voltage, and thereby varies the shape of the mirror film 12. The piezoelectric film 9 is formed of PZT (lead zirconate titanate, Pb(ZrₓTi₁₋ₓ)O₃)) or of a perovskite oxide that contains Nb and that is the same kind as PZT, with consideration given to its high piezoelectric constant, to the large displacement it produces under application of a voltage, and to the later-described relationship with the materials of the lower electrode film 8 and the upper electrode film 10.

There is no particular limitation to the thickness of the piezoelectric film 9. Too small a thickness, however, has the disadvantages of the piezoelectric film 9 exerting too weak a force and developing pin holes in it; too great a thickness, on the other hand, has the disadvantages of the piezoelectric film 9 taking too much time for its formation and requiring too high a voltage for its driving. Out of these considerations, it is preferable that the thickness of the piezoelectric film 9 be 0.5 μm or more but 5 μm or less.

The piezoelectric film 9 is formed by, for example, a sputtering process, vapor deposition process, chemical vapor deposition (CVD) process, sol-gel process, or aerosol deposition (AD) process; that is, any process may be used that can form thin films, and therefore there is no particular limitation to the thin-film formation process to be used.

The insulating film 11 is formed on the upper electrode film 10, so as to cover it. The existence of the insulating film 11 permits the mirror film 12, even when it is formed of an electrically conductive material, to be formed without its size being influenced by the shape of the upper electrode film 10. Moreover, even where, as in the embodiment, the upper electrode film 10 is divided into discreet segments, the mirror film 12, with the insulating film 11 interposed under it, can be formed flat and smooth.

The insulating film 11 is formed of, for example, resin such as polyimide or epoxy. The insulating film 11 is formed by, for example, a process whereby epoxy resin in liquid form is applied and then baked.

The mirror film 12 serves to reflect the laser beam emitted from the laser light source 2 (see FIG. 1) and the laser beam reflected from the recording medium 23 (see FIG. 1). Moreover, as the piezoelectric film 9 expands and contracts, the mirror film 12 varies its shape into the desired shape, thereby to serve to correct for aberrations, such as spherical aberration and coma aberration, that occur in the optical pickup apparatus 1 (see FIG. 1). Although the mirror film 12 is formed in an oval shape in the embodiment, this is not meant to be any limitation; it may instead be rectangular, circular, or of any other shape.

It is preferable that the mirror film 12 be formed of a high-reflectivity material; for example, it is formed as a film of a metal such as Au, Al, Ti, or Cr or an alloy thereof. The mirror film 12 may be composed of a plurality of films formed on one another. The mirror film 12 is formed by, for example, a sputtering process or vapor deposition process; that is, any process may be used that can form thin films, and therefore there is no particular limitation to the thin-film formation process to be used.

Next, the materials of the lower electrode film 8 and the upper electrode film 10 will be described. In the variable-shape mirror 6 of the embodiment, a close study has been conducted on those materials to achieve a structure that offers enhanced adhesion between the substrate 7 and the lower electrode film 8, between the piezoelectric film 9 and the lower electrode film 8, and between the piezoelectric film 9 and the upper electrode film 10. Since there is no material for the lower electrode film 8 that exhibits good adhesion to both the substrate 7 and the piezoelectric film 9, in the embodiment, the lower electrode film 8 is divided into a first layer 8a and a second layer 8b.

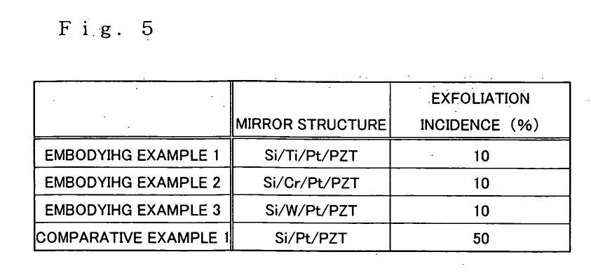

First, the adhesion between the lower electrode film 8 and the substrate 7, which is formed of silicon, will be described with reference to FIG. 5. It should be understood that the silicon of which the substrate 7 is formed here may be silicon with a partly oxidized surface. FIG. 5 is a table showing how the adhesion between the silicon substrate 7 and the first layer 8a of the lower electrode film 8 formed thereon is improved. In FIG. 5, the notation used to represent the variable-shape mirror structure is such that, for example, “Si/Ti/Pt/PZT” denotes that the substrate 7, the first layer 8a, the second layer 8b, and the piezoelectric film 9 are formed of Si, Ti, Pt, and PZT respectively. It should be understood that the PZT shown as the material of the piezoelectric film 9 here includes perovskite oxides that contain Nb and that are the same kind as PZT.

In FIG. 5, the percentage values given as the incidence of film exfoliation are the results of evaluation conducted in the following manner: after the thin-film layers were formed on one another on the substrate 7, the interface between the substrate 7 and the first layer 8a was inspected under a microscope to check if the film bulging or exfoliation was observed; if so, it was counted as one incidence of film exfoliation; this was repeated with a total of 10 samples inspected for each variable-shape mirror structure. The electrode film was formed by a sputtering process.

The results show the following. Using Ti, Cr, or W in the first layer 8a, which is formed on the substrate 7, helps reduce the incidence of film exfoliation to 10% from 50% experienced when the electrode film formed on the substrate 7 is formed of Pt as in comparative example 1. This attests to enhanced adhesion with the substrate 7. It can therefore be concluded that it is preferable to use Ti, Cr, or W in the first layer 8a of the lower electrode film 8. This however is not meant to limit the composition of the first layer 8a to Ti, Cr, or W; it is also possible to use instead an alloy of a composition containing two or more of Ti, Cr, and W or an alloy of a composition containing any of Ti, Cr, and W and another metal.

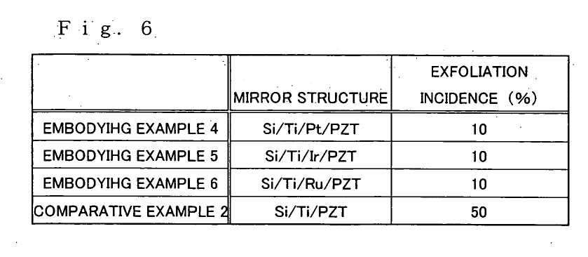

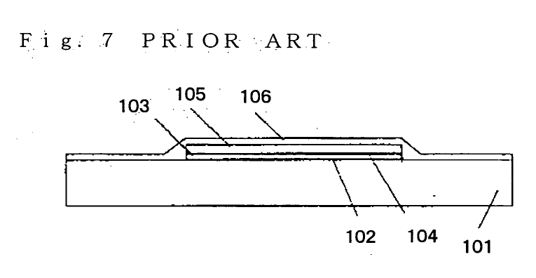

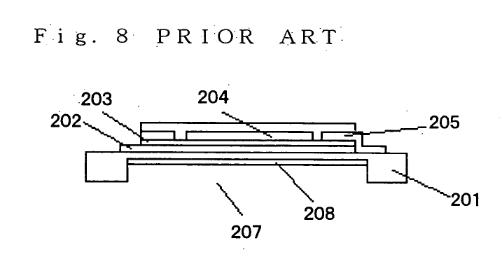

Next, the adhesion between the lower and upper electrode films 8 and 10 and the piezoelectric film 9 will be described with reference to FIG. 6. FIG. 6 is a table showing how the adhesion between the piezoelectric film 9 and the second layer 8b of the lower electrode film 8 formed thereon is improved. In FIG. 6, the same conventions are used to represent the variable-shape mirror structure and to give the incidence of film exfoliation as in FIG. 5, and therefore no explanations thereof will be repeated.

The results presented in FIG. 6 show the following. Using Pt, Ir, or Ru in the second layer 8b, which is formed on the piezoelectric film 9, helps reduce the incidence of film exfoliation to 10% from 50% experienced when the electrode film formed on the piezoelectric film 9 is formed of Ti as in comparative example 2. This attests to enhanced adhesion with the piezoelectric film 9. It can therefore be concluded that it is preferable to use Pt, Ir, or Ru in the second layer 8b of the lower electrode film 8 and in the upper electrode film 10, which like the second layer 8b is kept in contact with the piezoelectric film 9. This however is not meant to limit the composition of the second layer 8b to Pt, Ir, or Ru; it is also possible to use instead an alloy of a composition containing two or more of Pt, Ir, or Ru or an alloy of a composition containing any of Pt, Ir, or Ru and another metal. Inherently, the upper electrode film 10 suffers a comparatively low incidence of film exfoliation during the use of the variable-shape mirror; it may therefore be formed instead as a thin film of any other electrically conductive metal (e.g., Al, Ti, an alloy containing Al or Ti, or the like).

In the embodiment, the lower electrode film 8 is formed in two layers, namely the first layer 8a and the second layer 8b. It is however also possible to add one or more electrode layers between the first layer 8a and the second layer 8b. In that case, the electrode layer(s) formed between the first layer 8a and the second layer 8b may be a layer or layers of any electrically conductive metal. The lower electrode film 8 and the upper electrode film 10 are formed by, for example, a sputtering process or vapor deposition process; that is, any process may be used that can form thin films, and therefore there is no particular limitation to the thin-film formation process to be used.

An example of the fabrication procedure of the variable-shape mirror 6 of the embodiment structured as described above will be described below. First, on one side of the substrate 7, thin films are formed by a sputtering process or the like as described previously in the following order: the lower electrode film 8 (the first layer 8a and the second layer 8b), then the piezoelectric film 9, and then the upper electrode film 10 (first to third steps). Next, on the upper electrode film 10, resin in liquid form is applied and then baked to form the insulating film 11 (a forth step).

Next, the side of the substrate 7 opposite from the side thereof on which the lower electrode film 8 to the insulating film 11 have been formed is processed by a dry etching process until the substrate 7 has the desired thickness (e.g., 20 μm to 100 μm) (a fifth step). Thereafter, on the insulating film 11, the mirror film 12 is formed by a sputtering process or the like (a sixth step). Then, on the substrate 7, the lead conductors for the lower electrode film 8 and the upper electrode film 10 are patterned (a seventh step). Needless to say, the variable-shape mirror 6 may be fabricated through any other procedure.

The structure of the variable-shape mirror of the embodiment is not meant to be limited to what has been specifically described above, but may be modified into other structures. The following should however be noted: where a variable-shape mirror is formed with thin films, an electrode film sandwiched between the substrate and a piezoelectric film is particularly prone to film exfoliation; therefore, at least this electrode film needs to be formed of a substance that offers enhanced adhesion.

The embodiment deals with a case where a variable-shape mirror 6 according to the present invention is incorporated in an optical pickup apparatus 1; it should however be understood that variable-shape mirrors according to the present invention may also be applied to other optical apparatuses (e.g., optical apparatuses incorporated in digital cameras, projectors, and the like).

According to the present invention, a variable-shape mirror is provided with: a driver portion including a piezoelectric film and first and second electrode films that sandwich the piezoelectric film therebetween; a substrate formed on the first electrode film to support the driver portion; and a mirror film whose shape is varied as the driver portion is driven. Here, the first electrode film is formed of a plurality of layers of different compositions, and, of those layers, the one formed on the substrate is of such a composition as to exhibit enhanced adhesion to the substrate and the one formed on the piezoelectric film is of such a composition as to exhibit enhanced adhesion to the piezoelectric film.

With this structure, enhanced adhesion is obtained between the substrate and the part of the first electrode film kept in contact therewith and between the piezoelectric film and the part of the first electrode film kept in contact therewith. This helps prevent film exfoliation as has conventionally been experienced frequently in the electrode film sandwiched between the substrate and the piezoelectric film. Thus, variable-shape mirrors according to the present invention are less prone to breakage, and can be applied to optical apparatuses in a wide variety of fields.

An optical pickup apparatus incorporating a variable-shape mirror according to the present invention has enhanced adhesion between the substrate of the variable-shape mirror and the electrode film and between the electrode film and the piezoelectric film. Thus, it is less prone to breakage of the variable-shape mirror resulting from film exfoliation of the thin films provided therein, and thus offers enhanced durability. This helps realize very useful optical pickup apparatuses capable of correcting for aberrations.

What is claimed is:

1. A variable-shape mirror comprising:
a driver portion including a piezoelectric film and first and second electrode films that sandwich the piezoelectric film therebetween;
a substrate formed on the first electrode film to support the driver portion; and
a mirror film whose shape is varied as the driver portion is driven,
wherein the first electrode film is formed of a plurality of layers of different compositions, and, of the plurality of layers, the one formed on the substrate is of such a composition as to exhibit enhanced adhesion to the substrate and the one formed on the piezoelectric film is of such a composition as to exhibit enhanced adhesion to the piezoelectric film.

2. The variable-shape mirror according to claim 1,
wherein the substrate is formed of at least one material selected from the group of Si, SiO₂, and MgO,
wherein the piezoelectric film is formed of lead zirconate titanate (PZT) or of a perovskite oxide that contains Nb and that is a same kind as lead zirconate titanate (PZT),
wherein, of the plurality of layers, the one formed on the substrate is a metal layer of a composition containing at least one element selected from the group of Ti, Cr, and W, and
wherein, of the plurality of layers, the one formed on the piezoelectric film is a metal layer of a composition containing at least one element selected from the group of Pt, Ir, and Ru.

3. The variable-shape mirror according to claim 1,
wherein an insulating layer is formed on a surface of the second electrode film opposite from a surface thereof kept in contact with the piezoelectric film, and the mirror film is formed on a surface of the insulating layer opposite from a surface thereof kept in contact with the second electrode film.

4. The variable-shape mirror according to claim 1,
wherein part of the substrate where the driver portion is formed is wholly or partly given a thickness of 20 μm or more but 100 μm or less.

5. The variable-shape mirror according to claim 1,
wherein the piezoelectric film is given a thickness of 0.5 μm or more but 5 μm or less, and the second electrode film is given a thickness of 0.5 μm or less.

6. The variable-shape mirror according to claim 2,
wherein the second electrode film is a metal layer of a composition containing at least one element selected from the group of Pt, Ir, Ru, Al, and Ti.

7. The variable-shape mirror according to claim 2,
wherein an insulating layer is formed on a surface of the second electrode film opposite from a surface thereof kept in contact with the piezoelectric film, and the mirror film is formed on a surface of the insulating layer opposite from a surface thereof kept in contact with the second electrode film.

8. The variable-shape mirror according to claim 2,
wherein part of the substrate where the driver portion is formed is wholly or partly given a thickness of 20 μm or more but 100 μm or less.

9. The variable-shape mirror according to claim 2,
wherein the piezoelectric film is given a thickness of 0.5 μm or more but 5 μm or less, and the second electrode film is given a thickness of 0.5 μm or less.

10. An optical pickup apparatus comprising the variable-shape mirror according to claim 1.

11. An optical pickup apparatus comprising the variable-shape mirror according to claim 2.
